(19) United States
(12) Patent Application Publication
(10) Pub. No.: US 2008/0050017 A1
(43) Pub. Date: Feb. 28, 2008

(54) TRANSMISSION AND RECEPTION OF HANDWRITTEN DATA ON WIRELESS DEVICES WITHOUT CHARACTER RECOGNITION

(75) Inventors: Anand Monteiro, San Diego, CA (US); Sheshankh Reddy, San Diego, CA (US)

Correspondence Address: HUFFMAN LAW GROUP, P.C., 1900 MESA AVE., COLORADO SPRINGS, CO, 80906, US

(73) Assignee: VIA Telecom Co., Ltd, George Town (KY)

(21) Appl. No.: 11/467,188

(22) Filed: Aug. 25, 2006

(51) Int. Cl. G06K 9/00; G06K 9/36; G06K 9/46

(52) U.S. Cl. 382/187; 382/232

(57) ABSTRACT

A mobile device and associated method for transmitting a plurality of characters to a remote device without requiring keypad input or character recognition. The device is operable to receive characters entered by the user via handwritten input and transmit the characters without requiring character recognition. User input is received to a screen of the wireless handheld device, wherein the user input comprises handwritten text having a plurality of characters, e.g., in a non-Latin character set. Data corresponding to an image of the handwritten text may be compressed, packaged, and transmitted to a remote device in a wireless fashion. The compressed data is useable to create the image of the handwritten text on the remote device. The method preferably does not perform any character recognition on the handwritten text.

### FIELD OF THE INVENTION

The present invention relates generally to the transmission of data from/to a mobile device, particularly transmission of character data from/to a mobile device.

### DESCRIPTION OF THE RELATED ART

In recent years there has been a proliferation of wireless handheld devices used for information management and communication. Examples of such devices include personal digital assistants which offer various capabilities, including communication, such as the Palm Pilot or Blackberry. Where a Latin-based character set is being used, such wireless handheld devices typically include a small keypad for entering text. However, the use of non-Latin based character sets has presented difficulties in the design of such mobile devices.

Prior art mobile devices have used various techniques to input and transmit text data when a non-Latin based character set is used. One type of prior art mobile device uses keypad input which is language (character set) dependent, and which is also dependent on different manufacturer implementations. However, complex non-Latin character sets are cumbersome to enter through the keypad of such mobile devices. Users who enter non-Latin characters must master cumbersome input methodologies using the limited keypad. Further these input methodologies are not standardized across manufacturers, and thus the user is generally required to learn a different input methodology for different devices.

A second type of prior art mobile device has used language dependent character recognition. However, this generally requires that the mobile device have software for several character sets. For example, mobile devices used in geographical regions such as India generally require multiple character sets. Also, operators who are located in geographical regions that require multiple character sets must test and validate mobile handsets for several character sets. Further, devices which rely on character recognition technology must maintain large databases of language-dependent character sets and handwriting samples, and hence require large processing power on the device.

Therefore, an improved system and method is desired for entering and transmitting textual messages using mobile devices, particularly where the textual message is in a non-Latin character set.

### SUMMARY OF THE INVENTION

Embodiments of the invention comprise a mobile device and associated method for transmitting a plurality of characters to a remote device. The device is operable to receive characters entered by the user via handwritten input and transmit the characters without requiring character recognition.

The device may be a mobile or portable device, e.g., a wireless device. The device preferably comprises a housing having a screen, a processor, a memory, data-compression logic and communication circuitry, such as wireless communication circuitry. The device may also comprise a limited keypad, such as for numeric (telephone) input. The screen may be a touchscreen that is operable to receive user input comprising handwritten text having one or more characters. Alternatively, the device may be coupled to a screen, e.g., a touchscreen, which may allow the user to input hand-written characters. The memory is comprised in the housing and coupled to the processor and/or the screen and is operable to store data based on the user input, wherein the data corresponds to an image of the handwritten text. The data-compression logic is coupled to the memory and is operable to compress the data stored in the memory to produce compressed data. The wireless communication circuitry is coupled to at least one of the memory and/or the data-compression logic. The wireless communication circuitry is operable to transmit the compressed data to a remote device in a wireless fashion. On the remote device, the compressed data is useable to re-create the image of the handwritten text.

The method may comprise receiving user input to a screen of the wireless handheld device, wherein the user input comprises handwritten text having a plurality of characters, e.g., in a non-Latin character set. In response to the user input, data is stored in a memory of the wireless handheld device based on the user input, wherein the data corresponds to an image of the handwritten text. The data may then be compressed, optionally packaged, and transmitted to a remote device in a wireless fashion.

The method preferably does not perform any character recognition on the handwritten text. This obviates the necessity of storing various language dependent character recognition programs in the device, reduces the processor and power requirements of the device, and greatly simplifies testing and validation of the device. For example, devices used in geographical regions such as India, which have more than 10 different character sets, can easily transmit data without explicit support for each character set. Further, users are not required to master complex input methods using the keypad.

In one embodiment, a method for transmitting a plurality of characters from a mobile device is disclosed. The method comprises receiving user input to the mobile device. The user input comprises handwritten text having one or more characters. Moreover, the method further comprises storing data in a memory of the mobile device based on the user input. The data corresponds to an image of the handwritten text. In addition, the method further comprises compressing the data to produce compressed data and transmitting the compressed data to a remote device in a wireless fashion. The compressed data is useable to create the image of the handwritten text on the remote device.

In another embodiment, a device for transmitting a plurality of characters is disclosed. The device comprises a handwriting input unit operable to receive user input comprising handwritten text having one or more characters; a memory unit coupled to the handwriting input unit and operable to store data based on the user input, wherein the data corresponds to an image of the handwritten text; data-compression logic unit coupled to the memory unit and operable to compress the data stored in the memory to produce compressed data; and wireless communication unit coupled to the memory unit and the data-compression logic unit. T he wireless communication unit is operable to transmit the compressed data to a remote device in a wireless fashion, wherein the compressed data is useable to create the image of the handwritten text on the remote device.

In another embodiment, a method for receiving and displaying textual data on a wireless device is disclosed. The method comprises receiving compressed image data of handwritten text from a transmitting device on a wireless port of the wireless device; decompressing the compressed image data to produce uncompressed image data of handwritten text; and displaying the handwritten text based on the uncompressed image data.

In another embodiment, a device for receiving a plurality of characters comprises an input unit for receiving compressed image data of handwritten text from a transmitting device on a wireless port of the wireless device; a decompression unit coupled to the input for decompressing the compressed image data to produce uncompressed image data of handwritten text; and a display unit for displaying the handwritten text based on the uncompressed image data.

### BRIEF DESCRIPTION OF THE DRAWINGS

The foregoing, as well as other objects, features, and advantages of this invention may be more completely understood by reference to the following detailed description when read together with the accompanying drawings in which:

FIG. 1 illustrates an exemplary mobile device according to one embodiment of the invention;

FIG. 2 is a block diagram of the exemplary mobile device according to one embodiment of the invention;

FIG. 3 is a flowchart diagram illustrating input and transmission of a textual message according to one embodiment of the invention;

FIG. 4 is a flowchart diagram illustrating receipt and display of a received textual message according to one embodiment of the invention; and

FIG. 5 is a block diagram of an exemplary reception device according to one embodiment of the invention.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION OF THE EMBODIMENTS

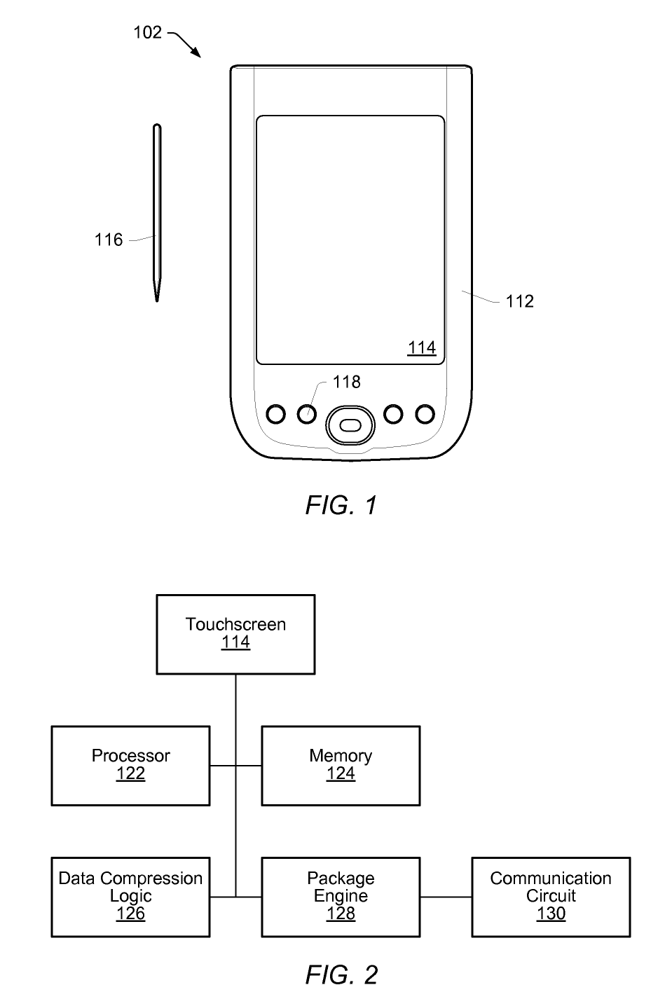

FIG. 1 illustrates a mobile or portable device 102 according to one embodiment of the invention. In one embodiment the device 102 is a wireless device, i.e., the device 102 is designed to communicate in a wireless fashion. As used herein, wireless communication may involve communication using AMPS, CDMA, GSM, 802.11, OFDM, WCDMA, Bluetooth, Infrared, and/or other wireless communication methods. In some embodiments, the device 102 is a handheld device, i.e., is designed such that it can be carried in a single hand of a user. In other embodiments, the device 102 may be a portable or mobile device that is not a handheld device. In some embodiments, the device 102 may be a portable telephone (e.g., a cellular telephone) that includes an input sensitive screen, such as a touchscreen. Additionally, or alternatively, the device 102 may be coupled to an external input sensitive screen, e.g., for inputting hand-written character data. Example embodiments of the device 102 may include personal digital assistants (PDAs) such as the Palm Pilot, Motorola Q, Blackberry, Hewlett Packard iPAQ, Motorola MPx, Samsung SPH-i500, and the T-Mobile Sidekick, among numerous others. Thus, according to various embodiments, the device 102 may be any appropriate device which may receive handwritten characters and transmit information wirelessly.

As shown, the portable device 102 includes a housing 112 which comprises a screen 114. The screen 114 may be connected to the housing 112 in such a way that the screen 114 is visible when the device 102 is in use. The screen 114 may be a touchscreen or touch sensitive screen that is operable to receive user input comprising handwritten text having a plurality of characters. The device 102 may also include a pen or stylus 116 or other similar apparatus used for providing input (e.g., handwriting input or drawing input) to the screen 114. In some embodiments, the device 102 may include a keypad 118 for entering input. For example, the device 102 may include a keypad for entering numerals (e.g., a telephone keypad). Alternatively, or in addition, the device 102 may have a keypad 118 for entering characters, e.g., a portion or all of a character set. However, in many embodiments, the screen 114 is the primary (or sole) mechanism for entering textual input, as described further below.

FIG. 2 is a block diagram of the portable device 102. As shown, the device 102 preferably comprises screen 114, a processor 122, a memory 124, data-compression logic 126, a package engine 128, and communication circuitry 130, such as wireless communication circuitry. The processor 122, memory 124, data-compression logic 126, package engine 128, and communication circuitry 130 are each preferably comprised in the housing 112 of device 102.

The processor 122 and memory 124 may be coupled together as well as to the screen 114. The memory 124 may store various operating system and/or application software for performing various applications such as one or more of calendaring/organizer/day planner, contact management, email, multimedia, or other applications. The memory is further operable to store data based on user input received to the screen 114, wherein the data corresponds to an image of handwritten text (or of images) entered by the user onto the screen 114.

The data-compression logic 126 is coupled to the memory and is operable to compress the data stored in the memory to produce compressed data. The data-compression logic may use any of various appropriate data-compression algorithms. In some embodiments, the data-compression logic 126 is implemented by data-compression software stored in the memory 124 and executed by the processor 122. In this embodiment, separate data-compression logic 126 is not required. Thus the term “data-compression logic” is intended to include dedicated or separate data-compression circuitry as well as data-compression software executed by the processor 122.

The package engine 128 may be coupled to the data-compression logic 126 and/or the memory 124. The package engine 128 may create packets for transmitting the data using various data packaging/transmission schemes or protocols, such as, for example, SMS, LMS, EMS, MMS, DTMF, FAX, Asynchronous Data Transmission, and/or TCP/IP, among others. In particular, the package engine 128 may generate SMS messages as it has become so ubiquitous and may be received by a wide variety of systems and devices. Additionally, the package engine 128 may generate concatenated SMS packets to transmit the image of the handwritten characters, as described below in more detail.

The communication circuitry 130 (e.g., wireless communication circuitry) is coupled to at least one of the memory 124, the data-compression logic 126, and/or the package engine 128. The wireless communication circuitry 130 is operable to transmit the compressed data to a remote device in a wireless fashion. The compressed data is useable to re-create the image of the handwritten text on the remote device.

The device 102 may be used with any of various character sets, including both Latin and non-Latin character sets. In at least some embodiments, the device 102 may be especially useful for non-Latin character sets. As used herein, the term “Latin” character sets has its ordinary meaning and for example refers to character sets which use the modern Latin alphabet, e.g., Romance (or Romanic) languages, Germanic languages (such as English, German, etc.), and/or other European languages. The term “non-Latin character sets” refers to character sets that are non-Latin, such as character sets used in China, India and Japan, among others. For example, the device 102 may be especially useful where the user inputs hand-written data in various Indian, Chinese, Japanese, and/or various other non-Latin languages. More specifically, the various languages may include Kanji, Hindi, Marathi, Gujarati, Punjabi, Bengali, Oriya, Kannada, Telugu, Tamil, Malayalam, Urdu, and/or Mandarin, among other languages. However, it should be noted that the languages described above are exemplary only and other languages are envisioned. Additionally, in some embodiments, as noted above, the device 102 may also be designed for all languages, e.g., including Latin character sets. In other words, the device 102 may be able to transmit characters without character-recognition in any language.

In at least some embodiments, the memory 124 does not store character recognition software for recognizing characters (text) entered by the user onto the screen 114. Rather, as discussed further below, characters or text entered by the user onto the screen 114 may be compressed and transmitted as images to one or more remote devices.

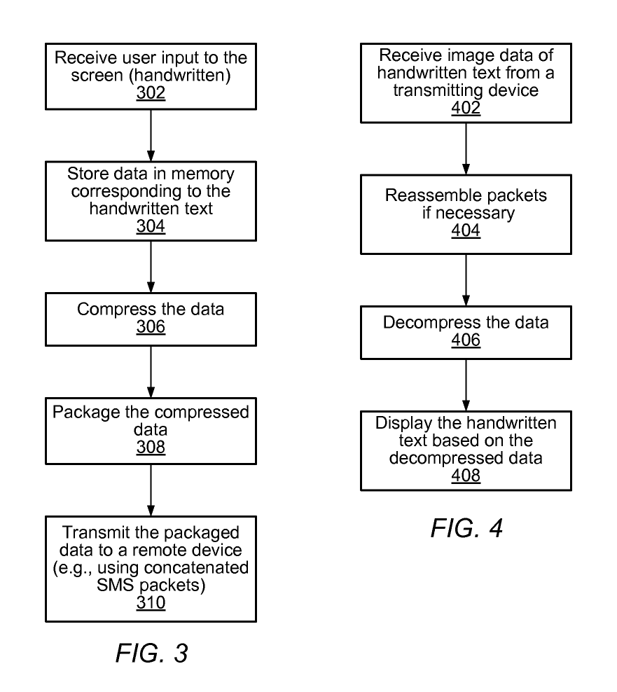

### FIG. 3—Exemplary Method for Transmitting a Plurality of Characters

FIG. 3 is a flowchart diagram illustrating a method for transmitting a plurality of characters from a wireless handheld device.

As shown, in 302, user input is received to the screen 114 of the wireless handheld device 102. The user input may be provided by pen or stylus 116 or other similar apparatus used for drawing images on a screen. The user input may comprise handwritten text having one or more characters, or a plurality of characters. As mentioned above, the handwritten character(s) may be of a non-Latin character set.

In 304, data is stored in the memory 124 of the wireless handheld device based on the user input. The stored data corresponds to an image of the handwritten text entered by the user in 302. For example, the data may be a bitmap representation of the character or image entered by the user in 302.

In 306, the data-compression logic 126 compresses the data to produce compressed data. The handwritten data may be compressed using standard data-compression algorithms including but not limited to FAX data compression algorithms, JPEG compression, and other types of image compression. The data compression may be lossless or lossy compression.

In 308, the compressed data may be packaged using package engine 128. The package engine 128 may create packets for transmitting the data using any of various protocols, such as SMS, MMS, TCP/IP, and/or other protocols, such as those listed above, among others. In one embodiment, the package engine 128 may create one or more SMS packets. For example, in one embodiment the package engine 128 may create a plurality of concatenated SMS packets, where the concatenated packets collectively contain the compressed data corresponding to the bitmap image of the characters entered by the user. In other words, the compressed data may be spread out over a plurality of packets, e.g., where the compressed data exceeds the size of an individual packet. For example, SMS packets may be restricted to 150 bytes and the compressed data may be several times larger than an individual SMS packet. In such cases, following the example above, the compressed data may be split into several packets which include information regarding their position in the compressed data, e.g., to facilitate aggregation of the packets into the full set of compressed data. Note that the descriptions above regarding SMS are exemplary only and that other methods or protocols may be used. Additionally, the concatenation described above may be applied to other protocols/transmission methods.

In 310, the compressed data is transmitted to a remote device in a wireless fashion. The compressed data is useable by the remote device to re-create the image of the handwritten text on the remote device. In one embodiment, transmission of the compressed data comprises generating packets based on the compressed data and transmitting the packets to the remote device in a wireless fashion. In 310 the compressed data may be transmitted as a plurality of concatenated SMS packets as mentioned above.

The data can be transmitted from the wireless device by methods which include but are not limited to the following: 1) Concatenated SMS (Short Message Services) messages. Short Message Services allow SMS transmission, where each SMS typically contains about 150 characters. The compressed image data can be transmitted by concatenating several SMS messages and reassembling these messages at the receiving device. Alternatively, the concatenated SMS can be received at a centralized server and re-formatted into any desired format for the target receiving device; 2) Wireless FAX; 3) MMS; and/or 4) Email with Image attachment, among others.

In at least some embodiments, the method for transmitting the handwritten text (the one or more characters) does not perform any character recognition on the handwritten text. As noted above, complex non-Latin character sets are cumbersome to enter through the keypad of mobile devices. Even simple drawings are difficult to input and transmit on present mobile devices. According to embodiments of the invention, a touchscreen 114 or other data entry device provides a much easier method to input handwritten data. The handwritten data includes but is not limited to language characters and image data. This data can be monochromatic or color depending on the capabilities of the device. This handwritten data does not require any type of processing for character recognition or image recognition.

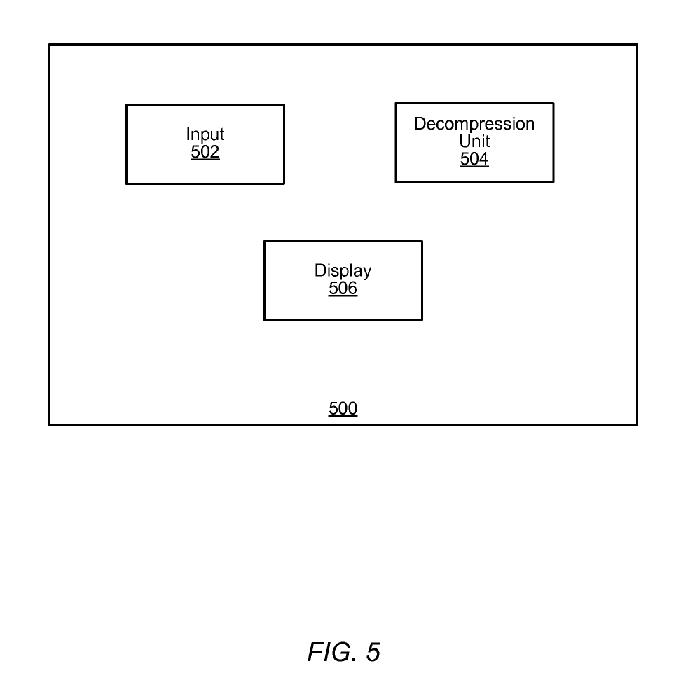

FIG. 4 is a flowchart diagram illustrating a method for receiving and displaying one or more characters transmitted from a wireless handheld device. FIG. 5 is an exemplary block diagram of a device operable to receive and display the one or more characters transmitted from the wireless handheld device. The system and method may include or omit system components and/or method elements as desired. Additionally, various ones of the method elements described below may be performed in a different order than shown or omitted entirely. As shown, the system and method may operate as follows.

As shown, in 402 image data of the handwritten text is received from a transmitting device. In some embodiments, the image data may be received via input 502 of reception device 500, shown in FIG. 5. In 404 the receiving device performs reassembly of packets, if necessary. In 406 the data is decompressed to produce the original data corresponding to the handwritten text (the data stored in 302 of FIG. 3). In one embodiment this may be performed by decompression unit 504 of the reception device 500. In 408 the handwritten text is displayed on display 506 of the receiving device 500 based on the decompressed data produced in 406. Thus, the receiving device 500 may include the input 502, the decompression unit 504 and the display 506 to receive and display the one or more characters transmitted from the wireless handheld device.

Although the embodiments above have been described in considerable detail, other versions are possible. Numerous variations and modifications will become apparent to those skilled in the art once the above disclosure is fully appreciated. It is intended that the following claims be interpreted to embrace all such variations and modifications. Note the section headings used herein are for organizational purposes only and are not meant to limit the description provided herein or the claims attached hereto.

1. A method for transmitting a plurality of characters from a mobile device, the method comprising:
receiving user input to the mobile device, wherein the user input comprises handwritten text having one or more characters;
storing data in a memory of the mobile device based on the user input, wherein the data corresponds to an image of the handwritten text;
compressing the data to produce compressed data; and
transmitting the compressed data to a remote device in a wireless fashion, wherein the compressed data is useable to create the image of the handwritten text on the remote device.

2. The method of claim 1, wherein the handwritten text corresponds to a character set which is not recognizable by the mobile device.

3. The method of claim 1, wherein the handwritten text corresponds to a non-Latin character set.

4. The method of claim 1, wherein the method for transmitting the plurality of characters does not perform any character recognition on the handwritten text.

5. The method of claim 1,
wherein said transmitting the compressed data comprises generating packets based on the compressed data and transmitting the packets to the remote device in a wireless fashion.

6. The method of claim 5, wherein the packets comprise a collection being selected from a group of:
short messaging service (SMS) packets;
enhanced messaging service (EMS) packets;
multi-media messaging service (MMS) packets; and
transmission control protocol/internet protocol (TCP/IP) packets.

7. A device for transmitting a plurality of characters, comprising:
a handwriting input unit operable to receive user input comprising handwritten text having one or more characters;
a memory unit coupled to the handwriting input unit and operable to store data based on the user input, wherein the data corresponds to an image of the handwritten text;
data-compression logic unit coupled to the memory unit and operable to compress the data stored in the memory to produce compressed data; and
wireless communication unit coupled to the memory unit and the data-compression logic unit, wherein the wireless communication unit is operable to transmit the compressed data to a remote device in a wireless fashion, wherein the compressed data is useable to create the image of the handwritten text on the remote device.

8. The device of claim 7, wherein the handwritten text corresponds to a character set which is not recognizable by the device.

9. The device of claim 7, wherein the handwritten text corresponds to a non-Latin character set.

10. The device of claim 7, wherein the device does not perform any character recognition on the handwritten text.

11. The device of claim 7, further comprising:
a package engine coupled to the data-compression logic unit and the wireless communication unit, wherein the package engine is operable to generate a plurality of concatenated packets based on the compressed data and provide the concatenated packets to the wireless communication unit for transmission.

12. The device of claim 11, wherein the concatenated packets comprise a collection being selected from a group of:
short messaging service (SMS) packets;
enhanced messaging service (EMS) packets;
multi-media messaging service (MMS) packets; and
transmission control protocol/internet protocol (TCP/IP) packets.

13. A method for receiving and displaying textual data on a wireless device, the method comprising:
receiving compressed image data of handwritten text from a transmitting device on a wireless port of the wireless device;
decompressing the compressed image data to produce uncompressed image data of handwritten text; and
displaying the handwritten text based on the uncompressed image data.

14. The method of claim 13, wherein the handwritten text corresponds to a character set which is not recognizable by the transmitting device.

15. The method of claim 13, wherein the handwritten text corresponds to a character set which is not recognizable by the wireless device.

16. The method of claim 13, wherein the receiving the compressed image data further comprises concatenating two or more packets based on the compressed image data.

17. The method of claim 16, wherein the packets comprise a collection being selected from a group of:
short messaging service (SMS) packets;
enhanced messaging service (EMS) packets;
multi-media messaging service (MMS) packets; and
transmission control protocol/internet protocol (TCP/IP) packets.

18. A device for receiving a plurality of characters, comprising:
an input unit for receiving compressed image data of handwritten text from a transmitting device on a wireless port of the wireless device;
a decompression unit coupled to the input for decompressing the compressed image data to produce uncompressed image data of handwritten text; and
a display unit for displaying the handwritten text based on the uncompressed image data.

19. The device of claim 18, wherein the input unit further comprises a concatenating unit for concatenating two or more packets based on the compressed image data.

20. The device of claim 19, wherein the packets comprise a collection being selected from a group of:
short messaging service (SMS) packets;
enhanced messaging service (EMS) packets;
multi-media messaging service (MMS) packets; and
transmission control protocol/internet protocol (TCP/IP) packets.
